(19) United States
(12) Patent Application Publication
(10) Pub. No.: US 2012/0306771 A1
(43) Pub. Date: Dec. 6, 2012

(54) TOUCH PANEL DISPLAY WITH IMPROVED PATTERN VISIBILITY

(75) Inventors: Cheng Chen, Cupertino, CA (US); EnkhAmgalan Dorjgotov, Cupertino, CA (US); Kuo-Hua Sung, San Jose, CA (US); Lili Huang, San Jose, CA (US); John Z. Zhong, Cupertino, CA (US)

(73) Assignee: APPLE INC., Cupertino, CA (US)

(21) Appl. No.: 13/153,769

(22) Filed: Jun. 6, 2011

(51) Int. Cl. G06F 3/041; B23P 11/00

(52) U.S. Cl. 345/173; 29/428

(57) ABSTRACT

Systems and methods are directed to reducing surface reflections on an electronic display device having a touch-screen panel. A touch-screen panel may contribute to undesirable reflection of external light. For example, a touch-screen panel typically includes conductive electrodes which may significantly reflect ambient light, resulting in decreased visibility of displayed images. In some embodiments, a circular polarizer is disposed over a touch-screen panel in the display device. The circular polarizer includes a linear polarizer and a quarter-wave plate to modify the polarization of the external light traveling towards and reflecting from the touch-screen panel and absorbing the reflected light from the touch-screen panel to significantly reduce undesirable light reflections from the touch-screen panel.

### BACKGROUND

The present disclosure relates generally to display devices, and more particularly, to techniques for controlling surface reflection on display devices.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Display technology may be used in a wide variety of electronic devices, including such consumer electronics as televisions, computers, and handheld devices (e.g., cellular telephones, audio and video players, gaming systems, and so forth). Such display devices typically provide a flat display in a relatively thin package that is suitable for use in a variety of electronic goods. In addition, touch-screen capabilities have become increasingly popular in such display devices. Such touch-screen capabilities enable a user to perform various functions by touching the display surface using a finger or other object at a location displayed on the display device.

A display device typically includes multiple layers, including a pixel matrix configured to selectively modulate the amount and color of light transmitted or emitted. Display devices having touch-screen capabilities also typically have a touch-screen panel including an arrangement of electrodes made of conductive materials. However, in some configurations of display devices, external light may be reflected from the touch-screen panel, resulting in undesirable light reflections from the display surface.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Techniques are provided for reducing reflections from display devices with touch capabilities. Typically, in display devices having touch-screen capabilities includes a touch-screen panel configured over a display panel. Examples of the display panel include liquid crystal displays (LCDs) and organic light emitting diode (OLED) displays. However, the touch-screen panel may contribute to undesirable light reflections. For instance, external light may pass through the top surface of the display device and be reflected from the touch-screen panel. In particular, the touch-screen panel may include an arrangement of conductive electrodes which significantly reflect external light. Undesirable reflections of external light may be perceived as glare and/or undesirable patterns and may reduce the visibility of the images displayed by the display device, particularly in bright ambient light environments. In some embodiments, a circular polarizer is positioned above the touch-screen panel (i.e., over the electrodes). A circular polarizer may include a linear polarizer and a quarter-wave (λ/4) plate. The circular polarizer may absorb a significant amount of the reflections from the touch-screen panel, particularly the reflections from the electrodes, thereby reducing undesirable light reflections from the touch-screen panel.

### BRIEF DESCRIPTION OF THE DRAWINGS

Various aspects of this disclosure may be better understood upon reading the following detailed description and upon reference to the drawings in which:

FIG. 1 is a block diagram of an electronic device, in accordance with aspects of the present disclosure;

FIG. 2 is a perspective view of a computer in accordance with aspects of the present disclosure;

FIG. 3 is a perspective view of a handheld electronic device in accordance with aspects of the present disclosure;

FIG. 4 is an exploded view of a liquid crystal display (LCD) in accordance with aspects of the present disclosure;

FIG. 5 is a schematic diagram illustrating light transmission and reflection patterns of the touch-screen panel illustrated in FIG. 4 in accordance with aspects of the present disclosure;

FIG. 6 is a side view of an arrangement of a display device having a touch-screen panel and a circular polarizer in accordance with aspects of the present disclosure; and

FIG. 7 is a schematic diagram of light transmission and reflection patterns of the display device configured as in FIG. 6 in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Certain embodiments of the present disclosure are generally directed towards reducing surface reflections on a display device. In display devices having touch-screen capabilities, a touch-screen panel is typically configured over the display panel. The touch-screen panel generally includes an arrangement of conductive electrodes. However, external light (e.g., ambient light, such as sunlight or artificial light) may be reflected from the touch-screen panel, and in particular, the electrodes of the touch-screen panel. Such undesirable light reflections may be perceived as glare and/or undesirable patterns on the display screen and may reduce the visibility of the displayed images, particularly in bright ambient light environments, such as the outdoors. More specifically, due to such undesirable light reflections, the electrodes may be visibly perceptible to a user.

In some embodiments, a display device includes a circular polarizer positioned above the touch-screen panel (i.e., over the electrodes of the touch-screen panel). In one of more embodiments, the circular polarizer includes a linear polarizer positioned over a quarter-wave plate. When external light travels toward the touch-screen panel of the display device, the light is first transmitted through the circular polarizer where it is polarized by the linear polarizer and phase-shifted by a quarter of its wavelength by the quarter-wave plate. The light is then reflected by a reflective surface, such as a touch electrode or other reflective portion of the touch-screen panel. As the reflected light travels away from the touch-screen panel, it is again phase shifted by the quarter-wave plate and absorbed by the linear polarizer of the circular polarizer. Therefore, by configuring a circular polarizer between the touch-screen panel and potential propagations of unpolarized light, reflections of unpolarized light from the touch-display device surface of the display device may be substantially decreased. With these foregoing features in mind, a general description of electronic devices including a display that may use the presently disclosed technique is provided below.

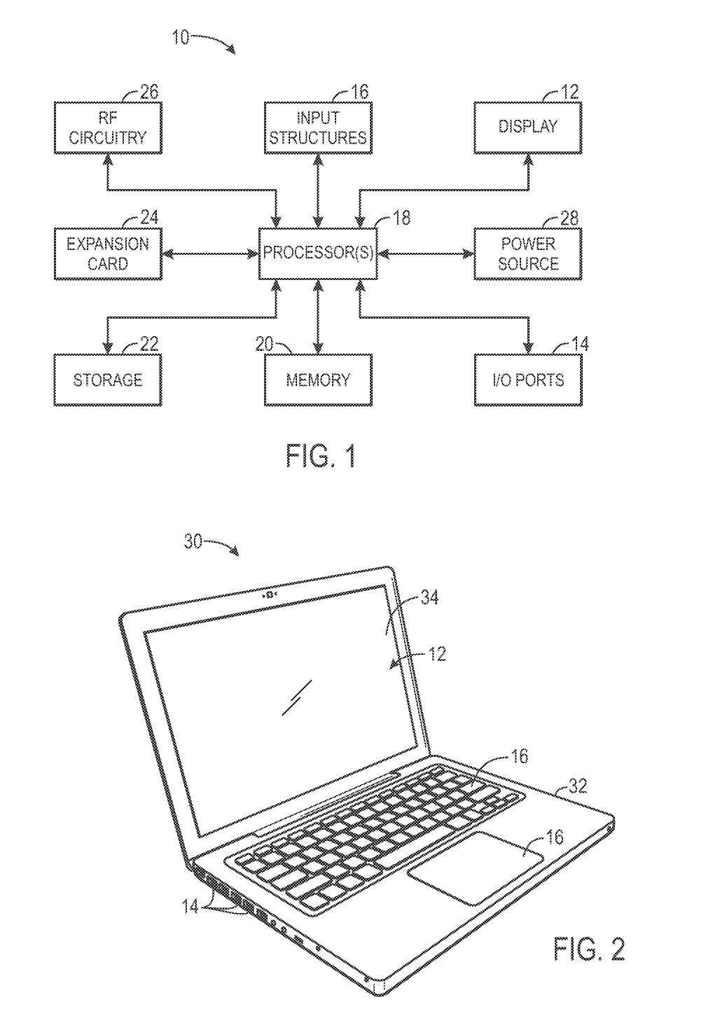

As may be appreciated, electronic devices may include various internal and/or external components which contribute to the function of the device. For instance, FIG. 1 is a block diagram illustrating components that may be present in one such electronic device 10. Those of ordinary skill in the art will appreciate that the various functional blocks shown in FIG. 1 may include hardware elements (including circuitry), software elements (including computer code stored on a computer-readable medium, such as a hard drive or system memory), or a combination of both hardware and software elements. FIG. 1 is only one example of a particular implementation and is merely intended to illustrate the types of components that may be present in the electronic device 10. For example, in the presently illustrated embodiment, these components may include a display 12, input/output (I/O) ports 14, input structures 16, one or more processors 18, one or more memory devices 20, non-volatile storage 22, expansion card(s) 24, networking device 26, and power source 28.

The display 12 may be used to display various images generated by the electronic device 10. The display 12 may be any suitable display, such as a liquid crystal display (LCD) or an organic light-emitting diode (OLED) display. Additionally, in certain embodiments of the electronic device 10, the display 12 may be provided in conjunction with a touch-sensitive element, such as a touch-screen, that may be used as part of the control interface for the device 10. For example, a touch-screen capable display 12 may include a touch-screen panel having an arrangement of electrodes. The display 12 may include a matrix of pixels and circuitry for modulating the transmittance of light through each pixel to display an image.

The electronic device 10 may take the form of a computer system or some other type of electronic device. Such computers may include computers that are generally portable (such as laptop, notebook, tablet, and handheld computers), as well as computers that are generally used in one place (such as conventional desktop computers, workstations and/or servers). In certain embodiments, electronic device 10 in the form of a computer may include a model of a MacBook®, MacBook® Pro, MacBook Air®, iMac®, Mac® mini, or Mac Pro® available from Apple Inc. of Cupertino, Calif. By way of example, an electronic device 10 in the form of a laptop computer 30 is illustrated in FIG. 2 in accordance with one embodiment. The depicted computer 30 includes a housing 32, a display 12 (e.g., in the form of a touch-sensitive display device 34, such as an LCD, OLED display, or some other suitable display configured with touch-sensitive capabilities), I/O ports 14, and input structures 16.

The display 12 may be integrated with the computer 30 (e.g., such as the display of the depicted laptop computer) or may be a standalone display that interfaces with the computer 30 using one of the I/O ports 14, such as via a DisplayPort, Digital Visual Interface (DVI), High-Definition Multimedia Interface (HDMI), or analog (D-sub) interface. For instance, in certain embodiments, such a standalone display 12 may be a model of an Apple Cinema Display®, available from Apple Inc.

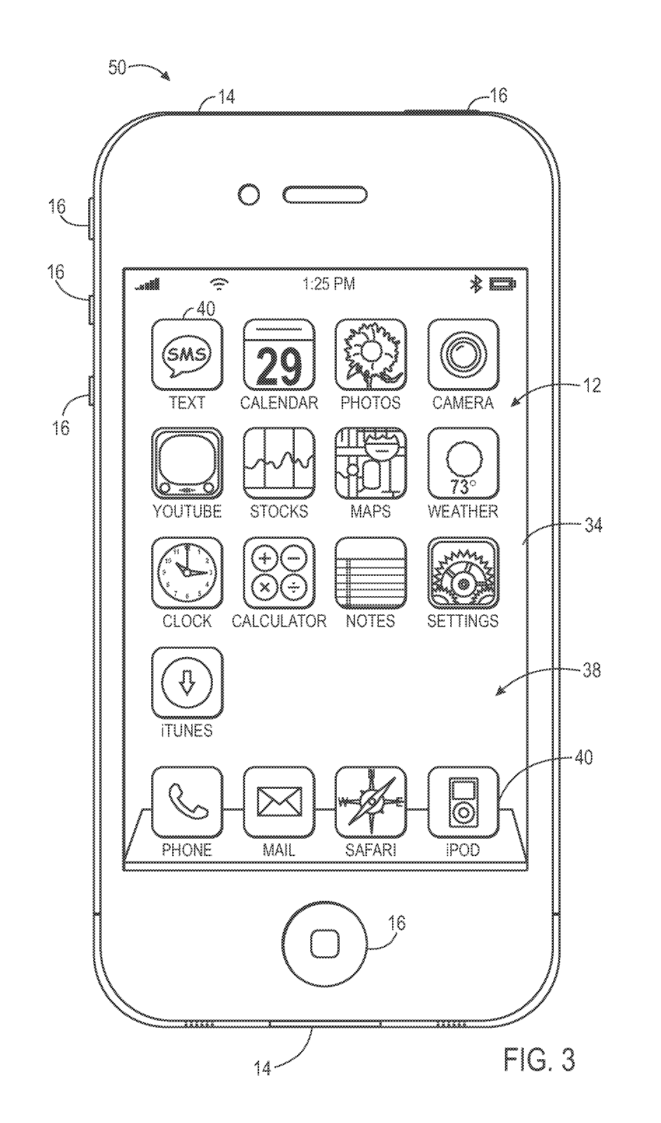

Although an electronic device 10 is generally depicted in the context of a computer in FIG. 2, an electronic device 10 may also take the form of other types of electronic devices. In some embodiments, various electronic devices 10 may include mobile telephones, media players, personal data organizers, handheld game platforms, cameras, and combinations of such devices. For instance, as generally depicted in FIG. 3, the device 10 may be provided in the form of handheld electronic device 36 that includes various functionalities (such as the ability to take pictures, make telephone calls, access the Internet, communicate via email, record audio and video, listen to music, play games, and connect to wireless networks). By way of further example, handheld device 36 may be a model of an iPod®, iPod® Touch, or iPhone® available from Apple Inc. In the depicted embodiment, the handheld device 32 includes the display 12, which may be in the form of a touch-sensitive display device 34. The touch-sensitive display device 34 may display various images generated by the handheld device 32, such as a graphical user interface (GUI) 38 having one or more icons 40. A user may perform various functions using touch-screen technology by touching a top surface of the touch-sensitive display device 34 and accessing the GUI 38.

In another embodiment, the electronic device 10 may also be provided in the form of a portable multi-function tablet computing device (not illustrated). In certain embodiments, the tablet computing device may provide the functionality of two or more of a media player, a web browser, a cellular phone, a gaming platform, a personal data organizer, and so forth. By way of example only, the tablet computing device may be a model of an iPad® tablet computer, available from Apple Inc.

With the foregoing discussion in mind, it may be appreciated that an electronic device 10 in either the form of a computer 30 (FIG. 2) or a handheld device 36 (FIG. 3) may be provided with a display device 10 in the form of a touch-sensitive display device 34. As discussed above, the touch-sensitive display device 34 may be utilized for displaying respective operating system and/or application graphical user interfaces running on the electronic device 10 and/or for displaying various data files, including textual, image, video data, or any other type of visual output data that may be associated with the operation of the electronic device 10. Moreover, in one or more embodiments, the electronic device 10 the touch-sensitive display device 34 may include a touch-screen panel.

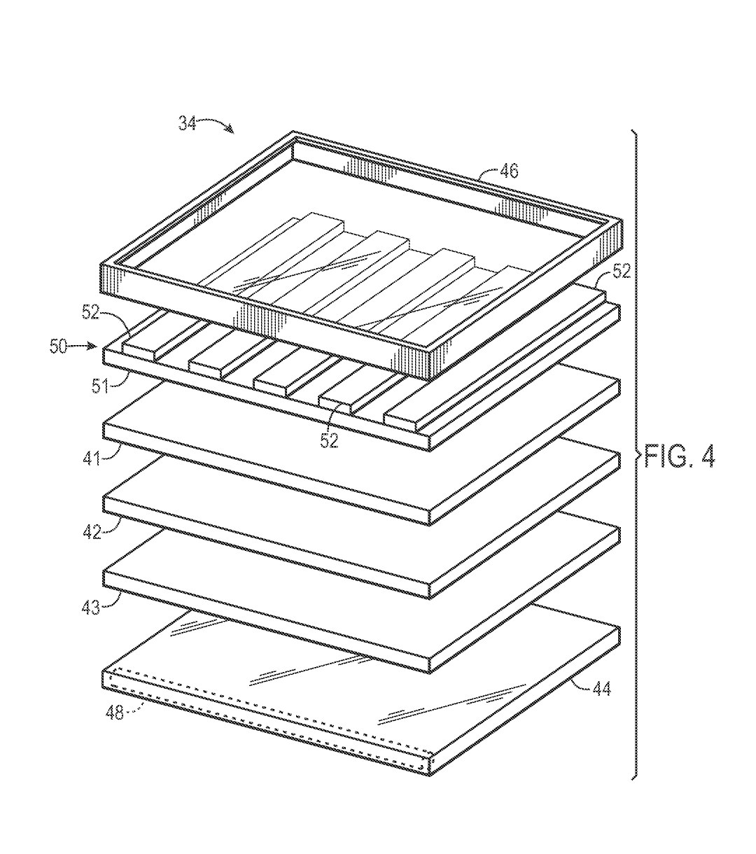

One example of a touch-sensitive display device 34 of an electronic display device 10 is depicted in FIG. 4 in accordance with one embodiment. The depicted touch-sensitive display device 34 includes one or more polarizing layers, such as a top polarizer 41 and a bottom polarizer 43, a display panel 42 (e.g., an LCD panel), a backlight unit 44, and a touch-screen panel 50, which may be assembled within a frame 46. In some embodiments, the frame 46 may fit around a transparent glass substrate, also referred to as the top surface of the touch-sensitive display device 34, which encloses the other panels of the touch-sensitive display device 34.

The backlight unit 44 includes one or more light sources 48. Light from the light source 48 is routed through portions of the backlight unit 44 (e.g., a light guide and optical films) and generally emitted toward the bottom polarizer 43 and the display panel 42. In various embodiments, light source 48 may include a cold-cathode fluorescent lamp (CCFL), one or more light emitting diodes (LEDs), or any other suitable source(s) of light. Further, although the touch-sensitive display device 34 is generally depicted as having an edge-lit backlight unit 44, it is noted that other arrangements may be used (e.g., direct backlighting) in full accordance with the present technique. The polarization of the light emitted by the backlight unit 44 may be controlled by the bottom polarizer 43. In some embodiments, the bottom polarizer 43 may polarize the light emitted out from the backlight unit 44 in substantially one direction, and the light polarized by the bottom polarizer 43 may propagate towards the display panel 42.

As may be appreciated, the display panel 42 may include an array of pixels configured to selectively modulate the amount and color of light passing from the backlight unit 44 through the bottom polarizer 43. For example, the display panel 42 may include an LCD panel including a liquid crystal layer, one or more thin film transistor (TFT) layers configured to control orientation of liquid crystals of the liquid crystal layer via an electric field, and polarizing films, which cooperate to enable the display panel 42 to control the amount of light emitted by each pixel. Additionally, the display panel 42 may include color filters that allow specific colors of light to be emitted from the pixels (e.g., red, green, and blue). In some embodiments, color filtered light may be polarized at a top polarizer 41.

The touch-screen panel 50 may be a substantially transparent panel disposed over the display panel 42 of the touch-sensitive display device 34. The touch-screen panel 50 may include a substrate 51 having electrodes 52 which may be arranged in a matrix or grid configuration or various other suitable configurations. In some embodiments, the electrodes 52 may be placed on one side or both sides of the substrate 51. During an operation of the touch-sensitive display device 34, a user may perform various functions by touching the top surface (e.g., the glass substrate in the frame 46) of the touch-sensitive display device 34 directly over certain positions on the touch-screen panel 50 using a finger or other object. During a touch of the top surface of the touch-sensitive display device 34, a capacitance may form in the touch-screen panel 50 between the touching finger or object and the electrodes 52 corresponding to the touched position. Based on the electrode(s) 52 of the touch-screen panel 50 in which a capacitance is formed, a processor (e.g., the processor 18, or another suitable processor coupled to the touch-sensitive display device 34 and/or to the touch-screen panel 50) may calculate and determine the position of the touch with respect to the touch-screen panel 50. The touched position may correspond with user interface functions (e.g., icons 40 of the GUI 38, as illustrated in FIG. 3) which are displayed through the display panel 42.

In some embodiments, the electrodes 52 of the touch-screen panel 50 may include conductive materials such as indium tin oxide (ITO), indium zinc oxide (IZO), silver, copper, aluminum, or other suitable metals. The substrate 51 of the touch-screen panel 50 over which the electrodes 52 are disposed may include a suitable transparent materials, such as glass, plastic, etc. The electrodes 52 may significantly reflect light, and may also have different light reflection and transmission properties than the substrate 51 of the touch-screen panel 50.

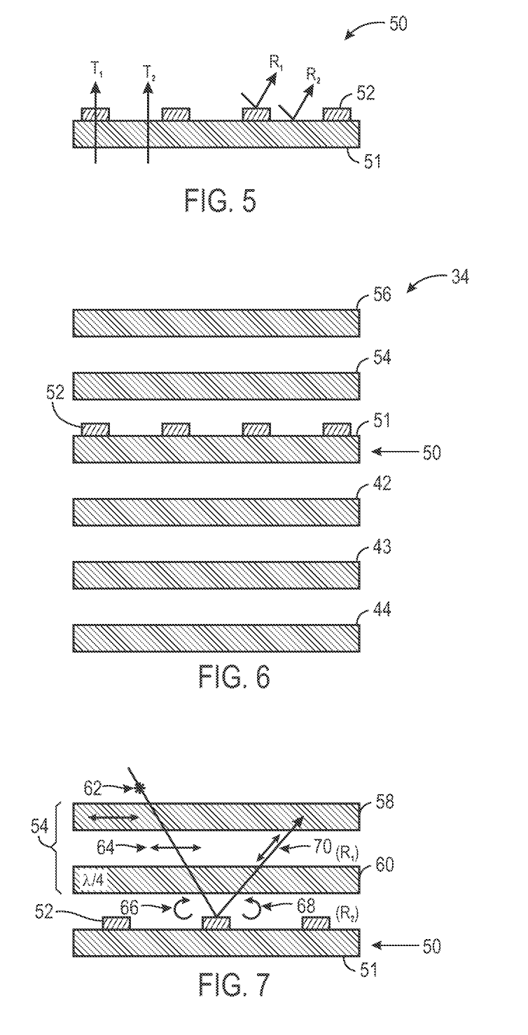

For example, FIG. 5 illustrates transmitted light T₁ and T₂ and reflected light R₁ and R₂ which may be transmitted through and reflected off the touch-screen panel 50, respectively. The transmitted light T₁ and T₂ and may include light from a backlight 44 (FIG. 4) which is transmitted through the display panel 42 and touch-screen panel 50 to display an image on the touch-sensitive display device 34. The source of the reflected light R₁ and R₂ may include light which travels towards the touch-screen panel 50 from outside the touch-sensitive display device 34. For example, the reflected light R₁ and R₂ may include light that is reflected from ambient or environmental light (e.g., sunlight, lamps). As illustrated in FIG. 5, the transmitted light T₁ and reflected light R₁ may be transmitted through and reflected from an electrode 52 of the touch-screen panel 50. The transmitted light T₂ and reflected light R₂ may be transmitted through and reflected from the substrate portion 51 of the touch-screen 50 that is not overlaid by an electrode 52.

Light may be transmitted and reflected differently throughout the touch-screen panel 50 due to different light reflection and transmission properties of the electrodes 52 and the substrate portions 51 of the touch-screen panel 50. For example, the transmitted light T₁ which travels through the substrate portion 51 and an electrode 52 of the touch-screen panel may be smaller (e.g., having a lower light intensity, having lower visual perceptibility) than the transmitted light T₂ through only the substrate portion 51 of the touch-screen panel 50. Further, the reflected light R₁ which is reflected from the electrode 52 may be greater (e.g., having a higher light intensity, having higher visual perceptibility) than the reflected light R₂ which is reflected from the substrate portion 51 of the touch-screen panel 50.

Such light transmission and reflection properties of the touch-screen panel 50 may result in undesirable visual effects on the touch-sensitive display device 34. For instance, the reflected light R₁ and R₂ may be perceived as glare on the image displayed by the touch-sensitive display device 34. Moreover, due to the different light transmission and reflection properties of the substrate portion 51 and the electrodes 52, the electrodes 52 may be visibly perceptible to a user, particularly in bright ambient light conditions, such as under direct sunlight or under a lamp. Such visibility of the electrodes 52 may interfere with a user's viewing of the images displayed by the touch-sensitive display device 34.

In one or more embodiments, as illustrated in FIG. 6, a display device such as a touch-sensitive display device 34 includes a circular polarizer 54 disposed over the touch-screen panel 50. While the circular polarizer 54 is depicted as one layer in FIG. 6, in some embodiments, the circular polarizer 54 may include multiple layers, as will be discussed with respect to FIG. 7. As previously discussed in FIG. 4, the touch-sensitive display device 34 includes the backlight 44, the bottom polarizer 43, the display panel 42, and the touch-screen panel 50. The circular polarizer 54 may be disposed over the touch-screen panel 50, and the touch-sensitive display device 34 may be covered with a top substrate 56. For example, in some embodiments, the top substrate 56 may be a transparent substrate, and may include glass, plastic, etc. The circular polarizer 54 may be configured to adhere to the bottom surface of the top substrate 56. The top substrate 56 may fit within a frame 46 (FIG. 4) to enclose the touch-sensitive display device 34. In some embodiments, a user can interact with the device 10 (FIG. 1) by touching a top surface of the top substrate 56 to form capacitances in certain positions of the touch-screen panel 50 which may correspond to user interface applications.

The circular polarizer 54 may significantly decrease the amount of reflected light R₁ and R₂ which exits the top surface of the top substrate 56 to be perceived by a user. As illustrated in FIG. 7, the circular polarizer 54 includes a linear polarizer 58 and a quarter-wave plate 60. When external light 62 propagates from external sources through the top substrate 56 of the touch-sensitive display device 34, it may be linearly polarized by the linear polarizer 58. Before passing through the linear polarizer 58, the external light 62 may be unpolarized, as represented in FIG. 7. The linear polarizer 58 may have a polarization and pass only light having the same polarization while absorbing light not having the same polarization. As such, the light passing through from the bottom surface of linear polarizer 58 may be portions of the external light having the same polarization as the linear polarizer 58. In some embodiments, the linearly polarized light 64 may be polarized by the linear polarizer 58 to a direction perpendicular to the direction of travel. For example, the linear polarizer 58 may have a polarization which is in-plane with the top surface of the touch-sensitive display device 34, which may be perpendicular to the direction of external light traveling toward the top surface of the touch-sensitive display device 34.

The linearly polarized light 64 may then pass through the quarter-wave plate 60, also referred to as a quarter-wave retardation film 60. The quarter-wave plate 60 may include one or multiple layers which, as a whole, is configured to optically retard (i.e., shift) the phase of light by approximately a quarter of the wavelength of the light. Generally, the quarter-wave plate 60 may shift the phase of the linearly polarized light 64 to make a 45° angle with the axis of travel of the light 64, resulting in changing the polarization of the linearly polarized light 64 to circularly polarized light. In one embodiment, the linearly polarized light 64 may pass through the quarter-wave plate 60 to become left-circularly polarized light 66. In some embodiments, the left-circularly polarized light 66 may be substantially circularly or elliptically polarized.

The left-circularly polarized light 66 may be reflected from the touch-screen panel 50 (e.g., from an electrode 52 or a substrate portion 51). As circularly polarized light typically changes orientation by a π/2 phase shift when it is reflected from a surface, the left-circularly polarized light 66 is reflected from the electrode 52 as right-circularly polarized light 68. The right-circularly polarized light 68 may pass through the quarter-wave plate 60, which again shifts the phase of the right-circularly polarized light 68, such that linearly polarized light 70 passes through the quarter-wave plate 60 after reflection at the electrode 52. The linearly polarized light 70 has a linear polarization which is substantially parallel to the direction of travel (e.g., the reflected light R₁). As the linearly polarized light 70 has a polarization that is perpendicular to the polarization of the linear polarizer 58, the linearly polarized light 70 may be substantially absorbed by the linear polarizer 58. Therefore, when external light travels through the circular polarizer 54 and is reflected from the electrode 52 or another portion of the touch-screen panel 50, the reflected light R₁ is absorbed by the circular polarizer 54, such that light reflections which may be perceived as glare or visible electrodes may be substantially reduced.

While FIG. 7 illustrates an effect of the circular polarizer 54 on reflected light R₁ which includes external light that is reflected from an electrode 52, it should be noted that the circular polarizer 54 may function similarly for reflected light R₂ from any other reflective surface (e.g., the substrate portion 51) of the touch-screen panel 50.

In different embodiments, the circular polarizer 54 may have various orientations. For instance, the linear polarizer 58 is not limited to a polarization direction that is perpendicular to the direction of light traveling toward the touch-screen panel 50, as described with respect to FIG. 7. In some embodiments, the linear polarization 58 may linearly polarize light to have any suitable polarization. Furthermore, the quarter-wave plate 60 in some embodiments may not necessarily polarize linearly polarized light 62 to left-circularly polarized light 64, and reflected right-circularly polarized light 68 to linearly polarized light 70, as discussed and illustrated in FIG. 7. In some embodiments, the quarter-wave plate 60 may phase-shift linearly polarized light to be either right-circularly polarized or left-circularly polarized, and may phase-shift either right-circularly polarized light or left-circularly polarized light to be linearly polarized.

Furthermore, while a capacitive touch-screen panel is described as one example of the touch-screen panel 50, in accordance with the present techniques, the circular polarizer 54 may reduce undesirable light reflections and/or transmissions from or through touch-screen panels 50 of various configurations. For example, in some embodiments, the circular polarizer 54 may reduce surface reflections and/or transmissions from resistive or infrared touch-screen panels 50.

Moreover, the present techniques of implementing a circular polarizer over a touch-screen panel may be applied to any suitable display device having a touch-screen panel. While LCDs are used as an example in this disclosure, the present techniques may also be implemented on other types of display devices, such as OLEDs.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A touch-screen device comprising:
a touch-screen panel comprising an arrangement of electrodes, wherein a user touch location over the arrangement of electrodes corresponds with a user interface function; and
a quarter-wave plate disposed over the touch-screen panel and a linear polarizer disposed above the quarter-wave plate, wherein the linear polarizer is configured to pass ambient light having a first linear polarization and not pass ambient light not having the first linear polarization, wherein the quarter-wave plate is configured to shift a phase of light having the first linear polarization such that light having the first linear polarization traveling through the quarter-wave plate and towards the touch-screen panel becomes circularly polarized in a first direction, and wherein the circularly polarized light reflected by the touch-screen panel is directed toward the quarter-wave plate which polarizes the reflected light into a second linear polarization substantially perpendicular to the first linear polarization, such that the light having the second linear polarization is substantially blocked by the linear polarizer.

2. The touch-screen device of claim 1, wherein the quarter-wave plate shifts the light having the first linear polarization by one-quarter wavelength before it is reflected off of the touch-screen panel and by another one-quarter wavelength after it reflects from the touch-screen panel and passes back through the quarter-wave plate.

3. The touch-screen device of claim 2, wherein the light passing back through the quarter-wave plate is linearly polarized in the second direction so that the linear polarizer substantially blocks all light reflecting from the touch-screen panel so that it does not reach a user of the touch-screen device.

4. The touch-screen device of claim 1, wherein the quarter-wave plate shifts the light having a first linear polarization by approximately 45 degrees to create the circularly polarized light in the first direction, wherein a reflection of the circularly polarized light in the first direction off of the touch-screen panel shifts a polarization of the circularly polarized light in the first direction by approximately 90 degrees to create circularly polarized light in a second direction, and wherein the quarter-wave plate shifts the circularly polarized light in the second direction by approximately 45 degrees to create the light having a second linear polarization polarized which is substantially perpendicular to the light having the first linear polarization.

5. The touch-screen device of claim 1, wherein the quarter-wave plate comprises a first surface and a second surface, wherein the first surface of the quarter-wave plate is facing the linear polarizer and wherein the second surface of the quarter-wave plate is configured to adhere to a top surface of the touch-screen panel.

6. The touch-screen device of claim 1, wherein the linear polarizer comprises a first surface and a second surface, wherein the first surface of the linear polarizer is configured to adhere to a top substrate of the touch-screen device and the second surface of the linear polarizer is facing the quarter-wave plate.

7. A display device comprising:
a top surface;
a circular polarizer disposed under the top surface;
a touch-screen panel disposed under the circular polarizer; and
a display panel disposed under the touch-screen panel.

8. The display device of claim 7, wherein the circular polarizer comprises:
a linear polarizer having a first polarization, wherein the linear polarizer is configured to pass light having the first linear polarization and absorb light not having the first linear polarization; and
a quarter-wave plate configured to shift a phase of light by approximately a quarter of a wavelength of the light.

9. The display device of claim 7, wherein the linear polarizer is configured to linearly polarize external light in the first linear polarization to pass light having the first linear polarization, wherein external light comprises light from one or more light sources external to the display device.

10. The display device of claim 9, wherein the quarter-wave plate is configured to shift a phase of the light having the first linear polarization by one-quarter wavelength before it is reflected off of the touch-screen panel and by another one-quarter wavelength after it reflects from the touch-screen panel and passes back through the quarter-wave plate.

11. The display device of claim 10, wherein the quarter-wave plate is configured to shift the phase of the light having the first polarization to pass light comprising a substantially circular polarization or a substantially elliptical polarization.

12. The display device of claim 9, wherein the quarter-wave plate shifts the phase of the light having the first linear polarization by 45 degrees to pass through a circularly polarized light in a first direction, wherein a reflection of the circularly polarized light in the first direction off of the touch-screen panel shifts a polarization of the circularly polarized light in the first direction by approximately 90 degrees to create circularly polarized light in a second direction, and wherein the quarter-wave plate shifts the circularly polarized light in the second direction by approximately 45 degrees to pass through light having a second linear polarization, wherein the light having the second linear polarization is substantially absorbed by the linear polarizer such that it does not pass through the top surface.

13. The display device of claim 7, comprising a backlight unit disposed under the display panel, wherein the backlight unit is configured to emit light towards the display panel.

14. A method of absorbing reflections from a touch-screen panel of a display device, the method comprising:
linearly polarizing external light passing through a top surface of the display device to pass a first linearly polarized light;
shifting a phase of the first linearly polarized light by approximately one-quarter wavelength to pass a first circularly polarized light toward a touch-screen panel;
shifting a phase of a second circularly polarized light reflected from the touch-screen panel by one-quarter wavelength to pass a second linearly polarized light; and
absorbing the second linearly polarized light, such that the second linearly polarized light does not substantially pass out of the top surface of the display device.

15. The method of claim 14, wherein linearly polarizing external light comprises using a linear polarizer to pass through portions of the external light having a first polarization substantially perpendicular to a direction of travel of the external light.

16. The method of claim 14, wherein shifting the phase of the first linearly polarized light comprises using a quarter-wave plate to pass the first circularly polarized light from a bottom surface of the quarter-wave plate toward the touch-screen panel.

17. The method of claim 14, wherein shifting the phase of the second circularly polarized light comprises using a quarter-wave plate to pass the second linearly polarized light, wherein the second circularly polarized light comprises a reflection of the first circularly polarized light from the touch-screen panel.

18. The method of claim 14, wherein absorbing the second linearly polarized light comprises using a linear polarizer to pass through only light polarized in a polarization of the first linearly polarized light and absorbing light not polarized in the polarization of the first linearly polarized light.

19. An electronic device comprising:
a memory unit configured to store one or more user interface functions;
a processing unit coupled to the memory unit, wherein the processing unit is configured to execute the one or more user interface functions;
a display surface, wherein the one or more user interface functions is activated by a user touch on the display surface;
a circular polarizer disposed under the display surface, wherein the circular polarizer is configured to modify a polarization of light a substantially absorb light not polarized to a first linear polarization;
a touch-screen panel disposed under the circular polarizer, wherein the user touch on the display surface corresponds with a user touch location of the touch-screen, and wherein the processing unit is configured to determine the user touch location and execute the one or more user interface functions based on the user touch location; and
a display panel disposed under the touch-screen panel, wherein the display panel is configured to emit selectively modulated light to be displayed through the display surface.

20. The electronic device of claim 19, wherein the circular polarizer comprises:
a linear polarizer disposed over the display panel and a quarter-wave plate disposed over the linear polarizer and under the display surface, wherein the linear polarizer is configured to pass through external light in the first linear polarization towards the quarter-wave plate, wherein the quarter-wave plate is configured to shift a phase of the light having the first linear polarization such that the light having the first linear polarization traveling through the quarter-wave plate and towards the touch-screen panel becomes circularly polarized in a first direction, and wherein the circularly polarized light reflected by the touch-screen panel is directed toward the quarter-wave plate which polarizes the reflected light into light having a second linear polarization, such that the light having the second linear polarization is substantially absorbed by the linear polarizer.

21. The electronic device of claim 19, comprising a backlight disposed under the display panel, wherein the backlight is configured to emit light towards the display panel, and wherein the display panel is configured to selectively modulate light emitted from the backlight.

22. A method of manufacturing a touch-screen device having reduced reflections, the method comprising:
providing a display panel configured to emit modulated light to be displayed through the touch-screen device;
disposing a touch-screen panel over the display panel, wherein the touch-screen panel is configured to be activated at one or more locations based on a user touch on a top surface of the touch-screen device, and wherein the one or more activated locations corresponds to one or more user interface functions of the touch-screen device; and
disposing a circular polarizer over the touch-screen panel and beneath the top surface of the touch-screen device, wherein the circular polarizer is configured to modify a polarization of light and substantially absorb light reflected from the touch-screen panel.

23. The method of claim 22, wherein the display panel comprises:
a backlight configured to emit light towards the top surface; and
a liquid crystal display (LCD) panel configured to modify the light emitted from the backlight to control an image displayed through the top surface.

24. The method of claim 23, comprising coupling a processor to one or more of the display panel and the touch screen panel, wherein the processor is configured to estimate the one or more activated locations of the touch-screen panel and determine the one or more user interface functions based on the estimated one or more activated locations.
